(19) United States
(12) Patent Application Publication
(10) Pub. No.: US 2007/0131666 A1
(43) Pub. Date: Jun. 14, 2007

(54) Heated mat apparatus

(76) Inventors: Mariah Gregg, Eagan, MN (US); Charles Garrett, Eagan, MN (US)

Correspondence Address: MERCHANT & GOULD PC, P.O. BOX 2903, MINNEAPOLIS, MN, 55402-0903, US

(21) Appl. No.: 11/282,113

(22) Filed: Nov. 16, 2005

(51) Int. Cl. H05B 3/00

(52) U.S. Cl. 219/213

(57) ABSTRACT

The present disclosure relates to a heated mat having a heater carried by a mat construction. The mat construction includes a mat layer with drainage openings positioned at a non-peripheral region of the mat layer to allow melted ice to flow through from the top side to the bottom side of the mat layer. A drainage space is positioned beneath the mat to allow water to flow underneath and away from the mat construction.

### TECHNICAL FIELD

The present invention relates generally to mats such as floor mats. More particularly, the present invention relates to mats that are heated to prevent the accumulation of ice.

### BACKGROUND

In cold weather climates, winter brings potentially dangerous conditions such as snow, ice, sleet, and frost. Accumulation of snow or ice on driveways, walkways, and doorsteps is a common occurrence during the winter months. To prevent accidents, such accumulation must be prevented or removed. Traditional snow removal devices, such as shovels or snowblowers, are not well-suited to use on stairways because such devices can be awkward and difficult to use in small spaces.

It is known in the prior art that one alternative to physical removal of snow or ice accumulation is the use of electrically heated mats. Prior art mat devices have encompassed various configurations and materials. The prior art mat devices have, however, left unsolved certain problems. Specifically, some prior art mats include an insulative material between the heating element and the ground to direct the heat upward. While such devices are capable of preventing accumulation of snow and ice, they are not constructed to effectively melt away existing accumulations. Other prior art mats do not provide adequate means for the water resulting from the melted snow or ice to drain.

### SUMMARY

One aspect of the present disclosure relates to a heated mat that provides for adequate drainage of the melted snow and ice so as to maintain a relatively dry surface to avoid accidents.

Another aspect of the present disclosure relates to a heated mat that provides the ability to effectively melt away existing snow or ice accumulations, in addition to preventing further accumulation.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a top, plan view of a heated mat apparatus having inventive aspects in accordance with the principles of the present disclosure;

FIG. 2 is a cross-sectional view taken along section line 2-2 of FIG. 1;

FIG. 3 is a cross-sectional view taken along section line 3-3 of FIG. 1;

FIG. 4 is a cross-sectional view taken along section line 4-4 of FIG. 1;

FIG. 5 is a cross-sectional view taken along section line 5-5 of FIG. 1;

FIG. 6 is a top, plan view of another heated mat apparatus having features that are examples of inventive aspects in accordance with the principles of the present disclosure; and

FIG. 7 is a bottom view of the heated mat apparatus of FIG. 6.

### DETAILED DESCRIPTION

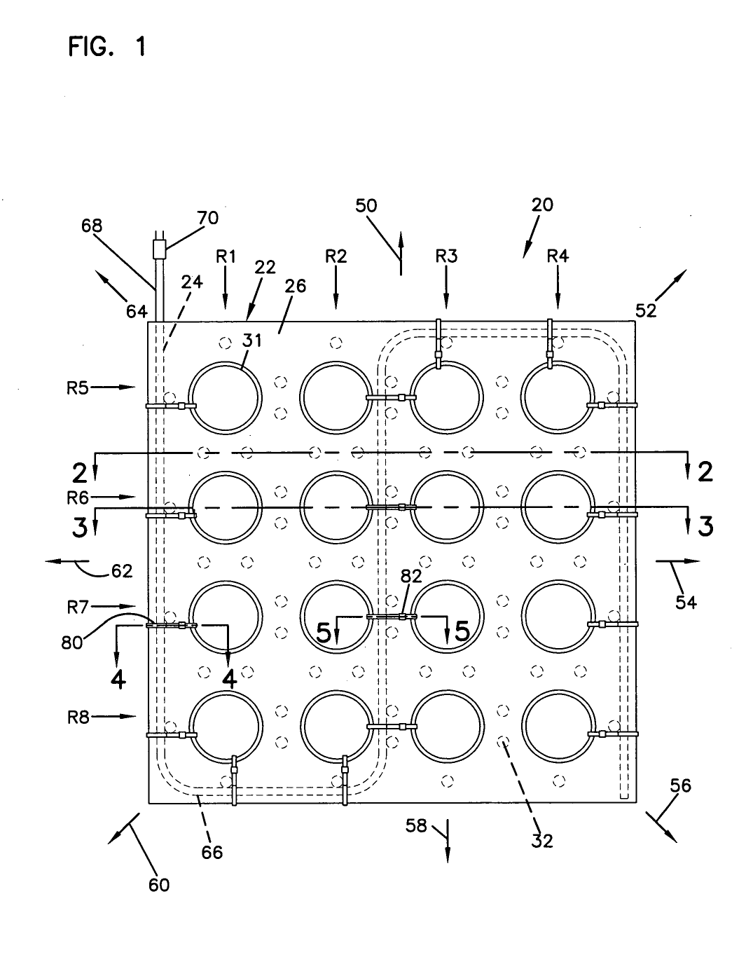

With reference now to the various drawing figures in which identical elements are numbered identically throughout, example embodiments incorporating the principles of the present disclosure will now be provided. FIGS. 1-7 represent example embodiments made according to the principles of the present disclosure. The example embodiments illustrated in FIGS. 1-7 are only some of the many configurations that can be built according to this disclosure.

FIGS. 1-5 illustrate a heated mat apparatus 20 having features that are examples of inventive aspects in accordance with the principles of the present disclosure. The apparatus 20 includes a mat 22 and a heater 24 carried by the mat 22. The mat 22 includes a main body forming a mat layer 26 having a top side 28 and a bottom side 30. A plurality of drainage openings 31 extend through the mat layer 26 from the top side 28 to the bottom side 30. The mat 22 also includes a plurality of spacers 32 that project downwardly from the bottom side 30 of the mat layer 26. The heater 24 extends in a serpentine pattern along the bottom side 30 of the mat layer 26

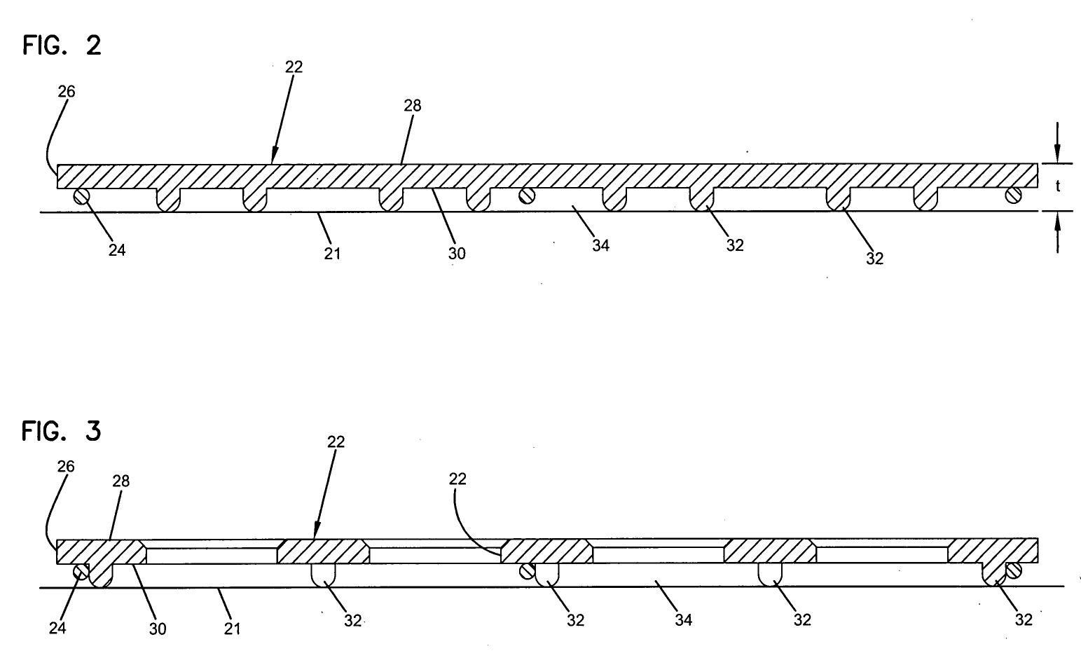

In use, the heated mat apparatus 20 can be laid upon a support surface 21 (shown at FIGS. 2 and 3) such as a floor, a deck, a patio, a sidewalk, or any other walking area where floor mats are typically used. The drainage openings 31 of the mat 22 allow water (e.g., from melted snow, sleet, slush, or other types of ice) to readily flow through the mat layer 26. The spacers 32 of the mat 22 elevate the bottom side 30 of the mat layer 26 above the support surface 21 to provide open space 34 beneath the mat layer 26. The open space 34 allows water that passes through the drainage openings 31 to flow beneath the mat layer 26 and away from the heated mat apparatus 20. The heater 24 can be used to prevent ice from accumulating on the heated mat apparatus 20, or to melt ice that has previously accumulated on the heated mat apparatus. Additionally, by placing the heated mat apparatus 20 over the top of an existing accumulation of ice on a support surface 21, the heated mat apparatus 20 can be used as an ice melting device for clearing ice from the support surface.

The mat 22 can be made of any acceptable material. Since the mat is intended to be used as a shoe cleaning device and will likely be subject to frequent shoe scuffing, the mat is preferably made of a relatively tough, abrasion resistant material. In one example embodiment, the mat includes a rubber-like material. A rubber-like material is any material that possesses properties, such as flexibility and durability, that resemble the material properties of rubber. Acceptable rubber-like materials include, but are not limited to, such materials as rubber, elastomers, polymeric materials, and plastics. In certain embodiments, the mat has a construction including a dielectric material.

To provide durability and to limit movement of the mat 22 in use, the mat 22 can be relatively heavy and thick. In one embodiment, the mat 22 has a thickness t of at least 0.25 inches. In another embodiment, the mat 22 has a thickness of at least 0.5 inches. In still another embodiment, the mat 22 has a thickness t of at least 0.75 inches.

The drainage openings 31 of the mat 22 can be formed in any shape or size provided they allow melted ice to flow from the top side to the bottom side of the mat layer. In one embodiment, the openings 31 each have a cross-sectional area of at least 0.2 square inches. In the depicted embodiment, the openings 31 are circular in shape and are outwardly chamfered adjacent the top side of the mat layer 26. Instead of chamfers, the openings 31 could also could be stepped outwardly adjacent the top side of the mat to increase the diameters of the openings at the top side of the mat.

The drainage openings 31 of the mat 22 can be located at both peripheral and non-peripheral regions of the mat layer 26. The peripheral region can include the portion of the mat layer 26 located within 2 inches of the outer perimeter of the mat layer 26. The non-peripheral region of the mat layer 26 includes all portions of the mat layer 26 except the peripheral portion. In the depicted embodiment, the drainage openings 31 are uniformly spaced across the entire surface area of the mat 22. For example, in the embodiment of FIG. 1, the drainage openings 31 are uniformly spaced from one another along first parallel rows R1-R4 that are generally perpendicular to second parallel rows R5-R8. In another example embodiment, the drainage openings are provided at a central region of the mat layer 26.

The open space 34 provided by the spacers 32 of FIG. 1 is configured to allow the flow of water in any direction beneath the mat layer 26. For example, depending upon the gradient of the support surface 21 upon which the mat 22 is placed, water can flow along the open space 34 beneath the mat layer 26 in direction 50, direction 52, direction 54, direction 56, direction 58, direction 60, direction 62, direction 64 or any other direction positioned between the labeled directions.

The spacers 32 of the mat 22 can be comprised of any material, in any shape or size, provided they serve to elevate the bottom side 30 of the mat layer 26 off of the support surface 21 to allow for drainage of melted ice or snow. In the depicted embodiment, the spacers 32 are integrally/unitarily formed with the mat layer 26.

To support the mat layer 26, the spacers 32 can be spaced across the bottom side of the mat layer 26 at both the peripheral and non-peripheral regions of the mat 22. To not interfere with drainage flow under the mat layer 26, the spacers 32 can each be relatively small. For example, in the depicted embodiment, the spacers 32 contact the support surface at areas that are substantially smaller than the cross-sectional areas of the drainage openings 31. In certain embodiments, the area of a selected drainage opening 31 is at least 2, 3, or 4 times larger than the support surface contact area of a selected spacer 32. The spacers 32 can also outnumber the drainage openings 31. For example, in certain embodiments, the mat 22 can include at least 2, 3 or 4 times more spacers than drainage openings 31. In certain embodiments, no individual spacer 32 is connected to the mat layer 26 along a significant length thereof.

In the depicted embodiment, the spacers 32 are constructed as posts. A post is any spacer having height as its longest dimension. Posts can be many different shapes and sizes and can be constructed out of any acceptable material. As shown at FIG. 1, the posts are arranged in a grid pattern having first and second perpendicular rows that are respectively positioned between the first and second rows R1-R4, R5-R8 of drainage openings.

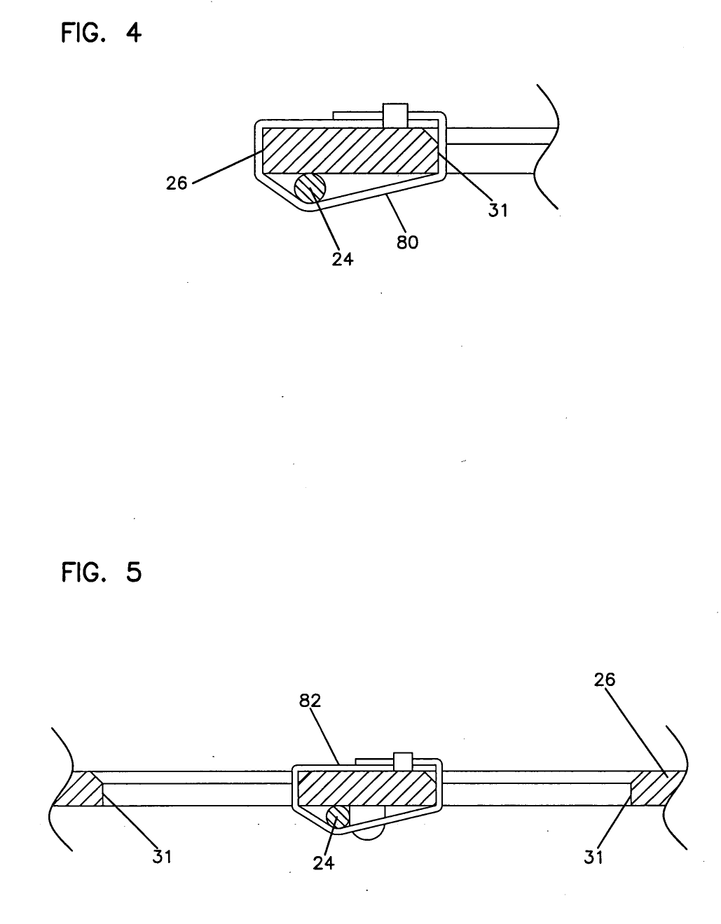

The heater 24 carried by the mat 22 prevents or removes accumulations of ice such as snow, sleet, or solid ice. As used herein, “carried by the mat” means that the heater 24 is attached or included within the mat construction such that movement of the mat results in movement of the heater. In one example embodiment, the heater 24 is attached to the mat and runs along the bottom side 30 of the mat layer 26. For example, the heater 24 can be secured to the mat 22 with loops such as ties, cinches, straps, cables, wires, or other structures. In the embodiment of FIG. 1, exterior loops 80 and interior loops 82 are used to secure the heater 24 to the mat 22. Each exterior loop 80 is routed through one of the drainage openings 31 and around the exterior of the mat 22 (see FIG. 4). The interior loops 82 are each routed through 2 drainage openings 31 (see FIG. 5). In other embodiments, the heater could run along the top side of the mat or could be incorporated/imbedded within the main body of the mat.

Referring to FIG. 1, the heater 24 includes a heating element 66 that extends in a serpentine pattern along the bottom side 30 of the mat layer 26. The serpentine pattern avoids intersecting or passing beneath the drainage openings 31 and the spacers 32. As shown at FIG. 2, the heating element 66 has a diameter that is less than the heights of the spacers 32. In this way, the heating element 66 is elevated above the support surface 21 and will not interfere with the flow of water beneath the mat. The heating element 66 can be an electric, resistive heating element. The heater 24 can include a cord 68 and a plug 70 that can be inserted into an electrical outlet to provide electricity for heating the resistive heating element 66.

The heater of the present invention could include many types of heaters. In one example embodiment, the heater includes an electric heater having a resistive heating element. One example of an acceptable electric heater would be an electric heating cable, such as the Electric Roof De-Icing Cable sold by Thermwell Products Co., Inc.

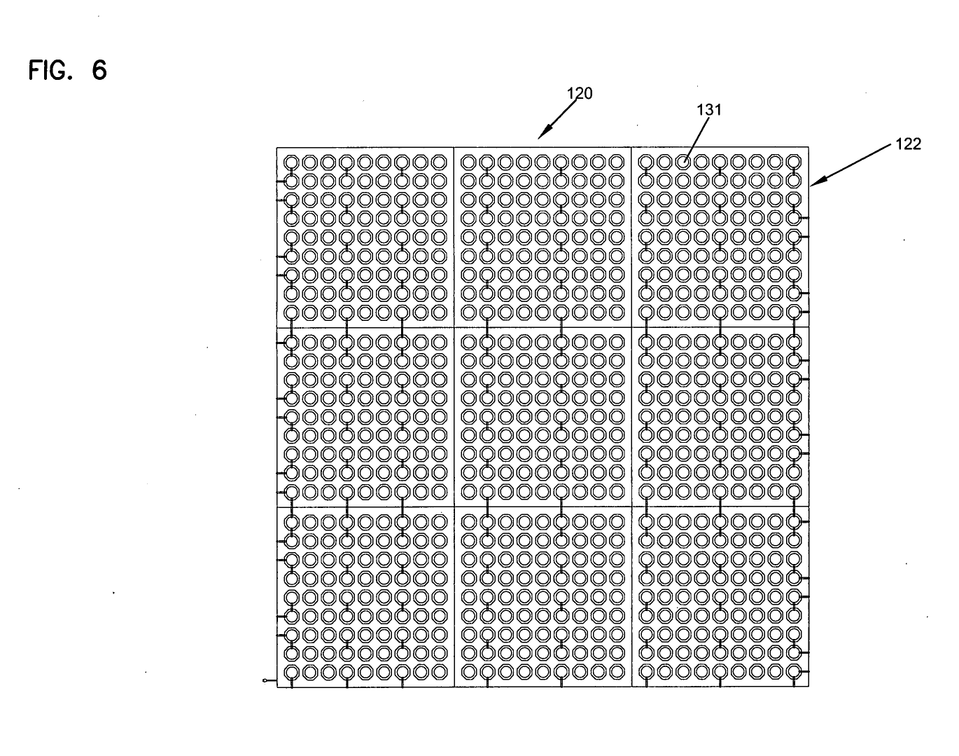

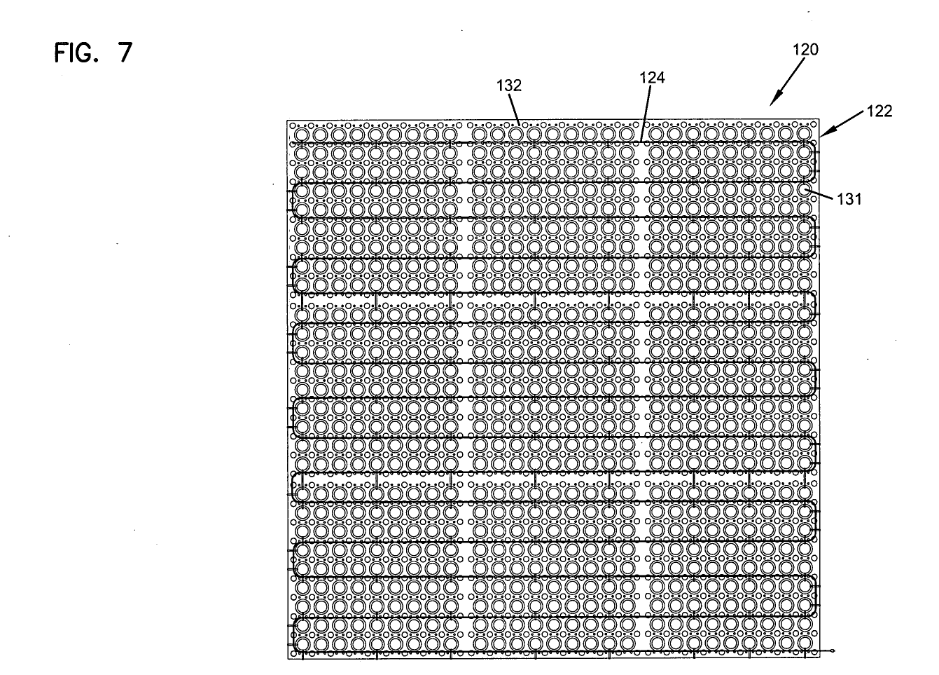

FIGS. 6 and 7 show another heated mat apparatus 120 having features that are examples of inventive aspects in accordance with the principles of the present disclosure. The apparatus includes a mat 122 and a heating element 124. The mat includes drainage openings 131 and bottom projections 132 for defining open drainage space beneath the mat 122. In one embodiment, the mat 122 is a 3 foot by 3 foot rubber mat having at least 60 drainage openings 131 per square foot. In another embodiment, the mat can include 40-120 discrete openings per square foot. In certain embodiments, the drainage openings 131 can be configured such that at least 10, 20, 30, or 40 percent of the mat surface area is open. In still other embodiments, the drainage openings can be configured such that 10-60 percent of the mat surface area is open.

The above specification, examples and data provide a complete description of the manufacture and use of an embodiment the invention. Since many embodiments of the invention can be made without departing from the spirit and scope of the invention, the invention resides in the claims hereinafter appended.

What is claimed is:

1. A heated mat apparatus comprising:
a mat construction having a thickness of at least 0.25 inches and including a rubber-like mat layer having a top side and a bottom side, the mat layer defining drainage openings at a non-peripheral region of the mat layer that extend through the mat layer from the top side to the bottom side;
the mat construction also including drainage space positioned beneath the mat layer for allowing water that passes through the drainage openings to flow under the mat layer and away from the mat construction; and
a heater carried by the mat construction.

2. The heated mat apparatus of claim 1, wherein the mat layer includes rubber.

3. The heated mat apparatus of claim 1, wherein the mat layer includes a polymeric material.

4. The heated mat apparatus of claim 1, wherein the heater includes an electric heater having a resistive heating element carried by the mat construction.

5. The heated mat apparatus of claim 4, wherein the resistive heating element extends in a serpentine pattern along the mat construction.

6. The heated mat apparatus of claim 1, wherein the drainage openings are provided at a central region of the mat layer.

7. A shoe cleaning apparatus for use on a support surface, the shoe cleaning apparatus comprising:
a mat including a main body having a top side and a bottom side, the main body defining a plurality of drainage openings that extend through the main body from the top side to the bottom side, the mat also including a plurality of spacers that project downwardly from the bottom side of the main body for spacing the bottom side of the main body above the support surface to provide open space beneath the mat for allowing water to drain from beneath the mat; and
a heating element carried by the mat.

8. The shoe cleaning apparatus of claim 7, wherein the drainage openings are provided at a non-peripheral region of the main body.

9. The shoe cleaning apparatus of claim 8, wherein the spacers allow water to flow in at least first and second directions beneath the mat, the first and second directions being generally perpendicular to one another.

10. The shoe cleaning apparatus of claim 8, wherein the spacers include posts.

11. The shoe cleaning apparatus of claim 8, wherein the mat has a rubber-like construction.

12. The shoe cleaning apparatus of claim 8, wherein the mat has a rubber construction.

13. The shoe cleaning apparatus of claim 8, wherein the mat has a polymeric material construction.

14 The shoe cleaning apparatus of claim 8, wherein the heating element extends in a serpentine pattern along the mat.

15. The shoe cleaning apparatus of claim 8, wherein the drain openings are provided at a central region of the mat layer.

16. A heated mat apparatus comprising:
a mat structure constructed of a rubber-like material, the mat structure having a top side and a bottom side, the mat structure defining drainage openings at a non-peripheral region of the mat structure that extend through the mat structure from the top side to the bottom side of the mat structure, the mat structure also including a plurality of downwardly projecting posts located at the bottom side of the mat structure; and
a heating element carried by the mat structure.

17. The heated mat apparatus of claim 16, wherein the drainage openings are arranged in a grid pattern including first and second perpendicular rows of drainage openings, wherein the posts are arranged in a grid pattern having first and second perpendicular rows of posts, and wherein the first and second rows of posts are respectively positioned between the first and second rows of drainage openings.

18. The heated mat apparatus of claim 17, wherein the heating element is arranged in a serpentine pattern.

19. The heated mat apparatus of claim 17, wherein the heating element is also capable of melting away existing ice accumulation from beneath the mat structure.

20. The heated mat apparatus of claim 18, wherein the heating element is secured to the mat structure with loops that extend through the drainage openings.
